(19) United States
(12) Patent Application Publication
(10) Pub. No.: US 2024/0271017 A1
(43) Pub. Date: Aug. 15, 2024

(54) Process for producing bio-based-cyclic anhydride monoester wood adhesives from bio-based powdered raw materials

(71) Applicant: Western Maple Bio Resources Inc., London (CA)

(72) Inventors: Zhongshun YUAN, London (CA); Chunbao XU, London (CA); Xia ZHOU, London (CA)

(21) Appl. No.: 18/645,536

(22) Filed: Apr. 25, 2024

Related U.S. Application Data
(63) Continuation of application No. PCT/CN2021/133269, filed on Nov. 25, 2021.

(30) Foreign Application Priority Data
Oct. 28, 2021 (CN) 202111259550.1

(51) Int. Cl. C09J 103/06; C09J 9/00

(52) U.S. Cl. CPC C09J 103/06; C09J 9/00

(57) ABSTRACT

A method for producing a seed powder-polycarboxylic acid monoester wood adhesive using a bio-based feedstock includes: generating a functionalized powder feedstock by moderate degradation of the powder feedstock with appropriate water content in the existence of a multifunctional catalyst and simultaneous esterification with a cyclic anhydride to introduce a curable functional group; and mixing the separated functionalized powder with water and adding a curing additive to form a thermo-curable wood adhesive. Double-layer plywood samples were prepared according to ASTM International Standard 2017, D2339-98 and solidified for 3-10 min under 3 MPa pressure in a hot press at temperatures between 150-200° C. The double-layer plywood samples showed dry and wet strengths of up to 3.5 MPa and a wood failure rate of more than 80%.

### TECHNICAL FIELD

The present invention relates to a process for obtaining a powdered poly carboxylic acid monoester formaldehyde-free wood adhesive by moderate degradation of grain flour or other starch-based substances as bio-based raw material.

### BACKGROUND

Formaldehyde-based resins (phenolic resins, urea-formaldehyde resins and melamine-formaldehyde resins) (PF, UF, MUF) are widely used in the wood industry as adhesives for engineered wood products such as plywood, particleboard, medium-density fiberboard (MDF) and oriented strand board (OSB).

Manufacturers of engineered wood products (plywood, particleboard (PB), medium density fiberboard (MDF), and oriented strand board (OSB)) are the world's largest consumers of formaldehyde-based resins/adhesives. However, the International Agency for Research on Cancer (IARC) classifies formaldehyde as a known human carcinogen (James A. et al, 2013). In 2016, the European Chemicals Agency (ECHA) classified formaldehyde as a carcinogen 1B compound in the Classification, Labeling and Packaging Regulation (CLP) (SUBSTANCE EVALUATION CONCLUSION as required by REACH Article 48). Therefore, the replacement of formaldehyde-based resins with low-cost bio-based formaldehyde-free adhesives will yield excellent environmental and economic benefits (Solt, Pia, et al., 2019).

Large quantities of low-grade or stale cereals are not suitable for human food consumption. In addition, in some countries, such as Canada, there is a large amount of surplus crop products that need to find valuable applications, as well as a large amount of agricultural land that is not well farmed. Therefore, there is still a huge scope for developing a carbon neutral sustainable economy based on crop products using cereal/flour/starch as a raw material. Formaldehyde-free bio-based adhesives (currently mainly starch and protein-based bio-binders or polyisocyanates) have been used as green alternatives to the formaldehyde-based adhesives mentioned above. Starch is usually physically or chemically modified, e.g. by graft curable functional groups on its hydroxyl groups, or using silica nanoparticles or other additives to strengthen its bond to wood. The main drawbacks of starch binders currently on the market are poor water resistance and short shelf life (Wang, Zhenjiong, et al., 2012).

### Technical Problems

Although several methods of preparing wood adhesives by hydrolyzing degraded starch have been reported in recent patents CN104910839A, CN104893629A, CN101974301A, with improved performance, but they need to use bio-oils, which is a complicated process, and the performance is far from the high strength and water-proof requirements.

In addition, soy protein is also a commonly used formaldehyde-free adhesive for wood under dry conditions, but its water resistance is poor, not to mention its high cost. Moreover, protein-based formaldehyde-free adhesives have a low strength of about 2.2 MPa, which is not sufficient for use.

Another type of formaldehyde-free adhesive on the market is polyisocyanates, such as polymethylene diphenyl diisocyanate (PMDI). Due to the high reactivity of the isocyanate groups with the hydroxyl groups in wood, this type of adhesive exhibits excellent wet and dry bond strength and fast curing. In addition to the high polluting production process of petrochemicals, a major disadvantage of isocyanates is their low tolerance of moisture content on the bonding surface due to the rapid reaction of water with the isocyanate, which generates carbon dioxide to form foams when the adhesive is applied. For wood materials, complete removal of moisture is very difficult and expensive, and over-drying can lead to distortion of the material. In addition, due to the toxicity of isocyanates, they can cause some health risks to operators on site.

Wheat, rice, corn, potatoes, sweet potatoes, cassava and wood flour are renewable resources that are abundantly available, and in many cases, low-grade or aged grains can be used as raw materials. With the rapid exhaustion of fossil resources, a new biorefinery industry is emerging to utilize the surplus low-grade or aged grain products to produce high value-added materials. Over the next 50-100 years, the Earth's agricultural land area could increase by nearly one-third. And, according to a recent study published in the journal PLOS One, Canada and Russia could be the main locations for these new agricultural frontiers, with 4.2 million and 4.3 million square kilometers of usable area each. Thus, there is enormous potential for the development of an agricultural bioeconomy.

Lignocellulosic biomass material, another potential raw materials for wood adhesives, has a low density and decentralized distribution features, due to regional differences leading to varying molecular structure and performance, so pre-treatment of biomass or subsequent processing brings certain difficulties.

### Technical Solutions

In order to solve the above problem, the present invention creates an additional profit for the agricultural sector by cost-effectively transforming surplus agricultural products into high-value green products bio-based formaldehyde-free wood adhesives in place of formaldehyde-containing petroleum-based wood adhesives.

The present invention provides a process for the production of a powdery polycarboxylic acid monoester wood adhesive from bio-based feedstock, wherein powder raw material of appropriate moisture content is moderately degraded in the presence of a multifunctional catalyst, while functionalized powder raw material is generated by esterification with cyclic anhydride to introduce curable functional groups; and wherein the separated functionalized powder is mixed with water and a curing agent is added to form a heat-curable wood adhesive.

Specifically, the present invention provides a process for producing powdery polycarboxylic acid monoester of a moderately degraded starch based agricultural product as a formaldehyde-free wood adhesive. Firstly, various starch-containing cereal powders under appropriate reaction conditions in the presence of a multifunctional catalyst are degraded into products of appropriate molecular size, while hydroxyl groups in their molecules react with cyclic anhydride to form a polycarboxylic acid mono-ester, so that the carboxylic acid groups are grafted onto polymeric constituents (cereal powders and/or starches). Secondly, the yielded powdery polycarboxylic acid monoester is then formulated into an adhesive by adding a curing agent, cross-linking agent, surfactant, stabilizer, etc., under aqueous or anhydrous conditions. In the wood processing process, in the presence of the compounded multifunctional curing agent, the carboxylic acid groups undergo esterification with the remaining hydroxyl groups of the adhesive itself and the hydroxyl groups in the wood constituents, and at the same time cross-linking between the double bonds of the unsaturated acids and cure agents to form a cross-linking to cure the adhesive layer. The process comprises:

In the existence of a multifunctional catalyst, in the presence of an organic solvent or in the absence of an organic solvent, the moderate degradation of a powder with a moderate water content and the esterification of some of the hydroxyl groups with cyclic polycarboxylic anhydrides (e.g., maleic anhydride, etc.) to produce a functionalized degraded powdery product is carried out; wherein the multifunctional catalyst is capable of catalyzing the moderate degradation of the flour and the esterification of anhydrides at the same time, so that the functionalized (esterified) product can be obtained in powder.

Typically, powders include grain flours and/or starches, such as flour and/or starch.

The powdery raw material, grain flour/starch may be a mixture form in any ratio of one or more of wheat flour, wild wheat flour, rice flour, wild rice flour, corn flour, potato flour, tapioca flour, soy flour, starch and the like.

In the present invention, the moisture content of the (starch-based) powdery raw material must be controlled within a certain range, which is helpful for controlling its moderate degradation and making the product suitable for certain viscosity and adhesive strength requirements, wherein water content is 2-10%, preferably 2-8%.

Degradation and esterification of powders can take place in organic solvents or under solvent-free conditions. When organic solvents are used, the esterification reaction takes place in solution by a non-homogeneous reaction in which one or more acids are used as catalysts. Post-reaction products are separated by filtration to get esterified powder, the filtrate is recycled and used in the next reaction. The solid part is washed with solvent and then dried by evaporation or vacuum drying, where various drying reaction equipment/processes can be used, to get powdery polyacid monoesters, while the washing solvent is recovered for reuse.

The esterification reaction can also be carried out in solvent or under solvent-free conditions. This is done by: (1) first moderately drying the dry powdery raw material (e.g., flour and or/starch), controlling the moisture content of the raw material by 2-10%, preferably 2-8%. (2) The mixture is then mixed well with cyclic anhydride and multifunctional catalyst, and the mixture is transferred to a glass/ceramic/metal reactor with stirring, a microwave reactor, or other type of rotating/mixing/extruding reactor, for example. The mixture is mixed and reacted at certain temperature for a specific period of time. After the reaction, the reaction mixture is cooled to room temperature. The solid product is then crushed and powered to obtain a functionalized powder.

Preferably, said cyclic anhydride is a cyclic polycarboxylic acid anhydride, specifically selected from a combination of any one or more of maleic anhydride, citric anhydride, itaconic anhydride, phthalic anhydride, succinic anhydride and methyl succinic anhydride, or anhydrides generated in-situ from polycarboxylic acids.

More preferably, in order to adapt to the properties of the biomass powder feedstock and to optimize the esterification reaction process, the combination of said cyclic anhydrides is optimum to be selected from an unsaturated anhydride or a combination of an unsaturated anhydride and a saturated anhydride; said saturated anhydride is selected from one or more of citric anhydride, phthalic anhydride, succinic anhydride, and said unsaturated anhydride is selected from one or more of maleic anhydride and itaconic anhydride.

Preferably, the ratio of said unsaturated anhydride to saturated anhydride is 1:0-2.

With the use of unsaturated anhydride and saturated anhydride, the unsaturated anhydride helps to increase the crosslinking degree and internal bonding of the functionalized powder during product curing, and the saturated anhydride decreases the curing temperature.

Wherein the loading amount of the acid anhydride may be 0.1-1 mol compared to 100 g of the powder material.

The step of acid anhydride esterification of the powdered material is carried out in the presence of a multifunctional catalyst, which simultaneously catalyzes the moderate degraded starch, and catalyzes the esterification of the acid anhydride.

The multifunctional catalyst is any one of the following or a combination thereof: Lewis acid, including ZnCl₂, FeCl₃, AlCl₃, BCl₃, BF₃, LaCl₃, SnCl₄, NH₄Cl, (NH₄)₂SO₄;

Bronsted acids, including sulfuric acid, phosphoric acid, toluene sulfonic acid; or other types of esterification catalysts such as tin esters, titanates.

A combination of Lewis acid and Bronsted acid/or ester is preferred, wherein the Lewis acid content is more than 60 wt %.

Said multifunctional catalyst is added in an amount of 0.5-8 wt %, preferably 1-6 wt % of the total amount of powder and anhydride.

The step of acid anhydride esterification of the powder is carried out at a weight ratio of acid anhydride to powder controlled at a ratio of 1:1 to 0.1:1 (w/w).

The esterification step can be carried out at a temperature in the range of about 60° C. to about 180° C. for about 5 minutes to about 10 hours, preferably in the range of 80-160° C. for 1 hour to 8 hours.

Wherein the esterification step can be carried out under polar organic solvents or under solvent-free conditions.

The said solvent can be one or a combination of acetone, tetrahydrofuran, acetonitrile, butanone, 1,4-dioxane, toluene, dichloromethane, dichloroethane, dimethylformamide, methyl isobutyl ketone, and said reaction can be carried out in a glass reactor with stirring or in an autoclave reactor.

When the reaction is carried out under solvent-free conditions, it can be carried out in a stirred glass/ceramic/metal reactor, a microwave reactor, or other type of rotary/combination/extrusion reactor.

Finally, the product functionalized powder is mixed with a curing additive, a cross-linking additive, a surfactant, and a stabilizer, and formulated in aqueous or anhydrous conditions to form a heat-curing (viscous liquid) wood adhesive, which can be used as a wood adhesive for the manufacture of wood panels, such as plywood, particleboards, MDF, or OSB, etc., at the curing temperature of between 130° C. and 220° C.

Wherein said curing agent is an acidic curing additive, selected from Lewis acids and/or Bronsted acids:

The said Lewis acid can be selected from any one of NH₄Cl, (NH₄)₂SO₄, (NH₄)₃PO₄, ZnCl₂, FeCl₃, AlCl₃, BCl₃, BF₃, LaCl₃, SnCl₄ or a combination thereof.

The said Bronsted acid, selected from any one of sulfuric acid, phosphoric acid, toluene sulfonic acid, or a combination thereof.

Preferably, the curing additive is composed of an ammonium Lewis acid and a Bronsted acid, the said ammonium Lewis acid can be selected from one of NH₄Cl, (NH₄)₂SO₄, (NH₄)₃PO₄, and said Bronsted acid can be selected from any one or a combination of sulfuric acid, phosphoric acid, and toluene sulfonic acid.

] The said curing additives can be commercial ammonium salt and Lewis acid concentration of 1-10 wt %, Bronsted acid concentration of 1-10 wt % are acceptable.

More preferably, the weight ratio of said ammonium Lewis acid to Bronsted acid is (1-6):1.

Wherein the ammonium salt Lewis acid such as NH₄Cl is used as a bifunctional curing additive, NH₃ is involved in the double bond crosslinking, and HCl, sulfuric acid, phosphoric acid, and toluene sulfonic acid catalyze the esterification crosslinking.

The inventor unexpectedly found that the use of the composite curing additive and controlling the appropriate ratio of the two is beneficial to the improved shear strength and wood failure rate of the wood product.

The formulation of the thermo-curable wood adhesive may also include additives such as surfactants, storage stabilizers (or anti-mold and anti-fungal agents), viscosity modifiers, and the like for adjusting the viscosity and homogeneity of the adhesive.

The thermo-curable wood adhesive produced may have formulation of a functionalized (esterified) powder: H₂O: curing additive:=20-60:30-80:5 weight ratio.

Depending on the actual need, the weight ratio of functionalized (esterified) powder: surfactant is 20-60:0.1-4.

The weight ratio of the functionalized (esterified) powder: stabilizer is =20-60:0.2-2.

Wherein the surfactant is selected from sodium p-toluene sulfonate, sodium dodecylbenzene sulfonate, sodium lignosulfonate, tweens and the like. The storage stabilizer (or anti-mold and anti-fungus agent) is selected from sodium polychlorophenate, sodium benzoate, etc., and the viscosity regulator is polyvinyl alcohol, flour, wood flour, etc. These additives promote long term storage and are not necessary to be added for ready-to-use applications.

Depending on the application, the thermo-curable wood adhesive can also be formulated as a powder.

The said process also includes applying the thermo-curable wood adhesive to the wood panel preparation and curing for about 2 to 10 minutes at a temperature in the range of about 140° C. to 220° C. under a pressure of about 1 to 8 MPa in a hot press.

The present invention also provides an application of a thermo-curable wood adhesive obtained by the preparation according to the process as described above to a wide variety of engineered wood products, said wood products being selected from plywood, particleboard, fiberboard, MDF, and OSB.

Consequently, the present invention provides for the preparation of thermo-curable wood adhesives, and the production of wood panels bonded with thermo-curable wood adhesives.

The following detailed description provides a further understanding of the functional and advantageous aspects of the present invention.

### Beneficial Effects

Beneficial effects of the present invention:

1. The utilization of a bio-based formaldehyde-free wood adhesive has the following unique features: excellent dry/wet bond strength and water resistance; a kind of non-toxic, non-hazardous, formaldehyde-free product; competitive cost that is much lower than that of pMDI and protein-based adhesives; sourcing from bio-renewable feedstocks; and a green production process with no environmental pollution.

2. The present invention improves the esterification effect of biomass powders by adjusting the type and amount of anhydride and using one or more anhydrides in coordination, to obtain a high performance thermo-curable wood adhesive.

3.The present invention also seeks to optimize the combination of curing additives, in the presence of multifunctional curing additives, which not only participate in double-bond cross-linking, but also catalyze esterification cross-linking at the same time to form a strong cured adhesive layer.

4. The enforcement process of invention is simple and easy to control, which is conducive to industrialization. It can be scale up to pilot/mass production of bio-based formaldehyde-free wood adhesives from cereals and starch-based materials, which will have significant economic and environmental benefits for the agricultural sector as well as the resin/adhesive industry and promote the emerging circular bio-economy.

### BRIEF DESCRIPTION OF THE DRAWINGS

FIG. 1 is the IR spectra of wheat flour (a) and powdered-MA products (b).

FIG. 2 is the H¹-NMR spectra of powdered-MA products.

FIG. 3 is the dry/wet shear strength of the two-layer plywood bonded with powder-based wood adhesives under different curing conditions.

FIGs. 4 is the dry/wet shear strength of the two-layer plywood samples using wood adhesives with SA and PTSA as curing catalysts at 170° C. for 8 minutes.

### DETAILED DESCRIPTION OF THE EXAMPLES

Various Examples and aspects of the present invention will be described with reference to the details discussed below. The following description is illustrative of the invention and should not be construed a limitation of the invention. Many specific details are described to provide a thorough understanding of various Examples of the present invention. However, in some instances, well-known or conventional details are not described to provide a concise discussion of embodiments of the present invention.

As used in this document, the terms “comprises” and “comprising” should be construed as inclusive and open-ended, and not exclusive. Specifically, when used in the specification and claims, the terms “comprises” and “including” and variations thereof imply the inclusion of specified features, steps, or components. These terms should not be construed to exclude the presence of other features, steps, or components.

As used in this document, the term “exemplary” means “used as an example, instance, or illustration” and should not be construed to be preferred over or superior to other configurations disclosed herein.

As used in this document, the terms “about” and “approximately” are intended to cover variations that may exist in the upper and lower mid-range values of the range, such as variations in characteristics, parameters, and dimensions. In a non-limiting example, the terms “about” and “approximately” indicate plus or minus 10% or less.

Unless otherwise defined, all technical and scientific terms used herein are intended to have the same meaning as commonly understood by those of ordinary skill in this document.

In the present invention, a new process is disclosed for an inexpensive bio-based formaldehyde-free wood adhesive made from grain flour or other starch-based materials. In the process, first, under mild conditions (from about 80° C. to 180° C., and from about 5 minutes to 10 hours), the grain semolina or starch is modified in the presence or absence of organic solvents (including acetone, tetrahydrofuran, acetonitrile, butanone, 1,4-dioxane, methylene chloride, ethylene dichloride, methyl isobutyl ketone, butanone, and dimethylformamide) or in the absence of solvents by combining it with cyclic polycarboxylic anhydrides (e.g., maleic anhydride, citric anhydride, phthalic anhydride, succinic anhydride, methyl succinic anhydride, and the like) are modified to introduce curable functional groups, while the weight ratio of the anhydride to the flour is controlled to be in a ratio of about 1:1 to 0.1:1.

After the reaction, the solvent is removed by filtration and the solvent can be recycled for the esterification step. The solid is dried in a rotary evaporator and the solvent remaining in the solid is recovered. Water and the solidifier are then mixed together with the functionalized powder, and the mixture is then emulsified with an emulsifier to form a thermal curable wood adhesive.

The adhesive can be used to manufacture wood panels, such as plywood or other engineered wood products, cured at about 140° C. to 220° C., preferably at about 150° C. to about 210° C., by holding the adhesive in a hot press at a pressure of about 1 to 8 MPa for about 3 to 10 minutes. These biobased formaldehyde-free wood adhesives are not only inexpensive, but also exhibit excellent wet and dry bond strength and therefore excellent water resistance.

The bio-based formaldehyde-free wood adhesives obtained using the preparation process of the present invention can substitute commercial formaldehyde-based resins (UF, MUF, and PF) as well as other formaldehyde-free adhesives (e.g., pMDI and soy protein-based adhesives) for a wide range of applications in engineering wood products.

The process of the present invention will now be illustrated using the following non-limiting and exemplary Examples.

### EXAMPLE 1

### Preparation of MA-Esterified Flour: Flour-Maleate (FL-MA)

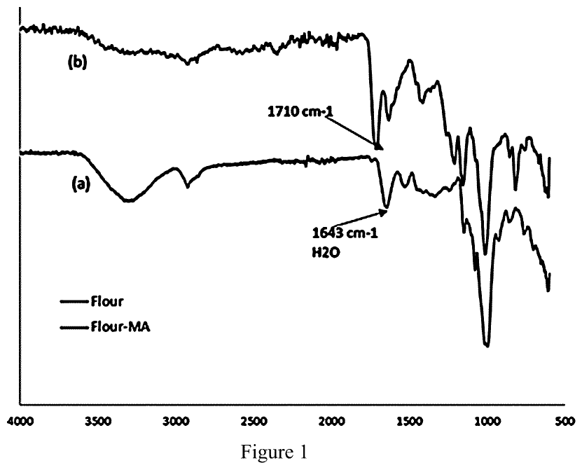

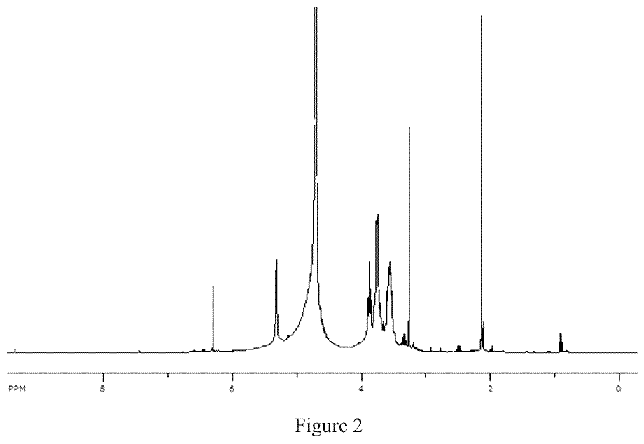

Wheat flour containing 12% water was dried in a vacuum oven at 100° C. for 12 h. The moisture was detected as 5% by a Karl Fischer moisture meter. 162.0 g of dried wheat flour was loaded into a 1000 ml three-necked flask equipped with a thermometer on one side of the neck and a condenser for solvent reflux on the other side of the neck, followed by the addition of 98.0 g of maleic anhydride (MA), the addition of 6.50 g of ZnCl₂ as a catalyst and the addition of 400 ml of acetonitrile. The flask was heated and stirred in an oil bath at 90° C. for 5 hours. A sample was analyzed by GC (gas chromatography) and the maleic anhydride conversion was about 55%. The reaction mixture was filtered and washed with reaction solvent to remove the catalyst and unreacted MA. The solid was evaporated under reduced pressure using a rotary evaporator to recover the remaining solvent. 218.1 g of dry powdery-MA product was obtained. The powdery-MA product was analyzed by IR spectroscopy (FIG. 1) and NMR spectroscopy (FIG. 2). The solvent can be recycled and reused in the next reaction.

In FIG. 1, spectrum (a) is the infrared spectrum of raw wheat flour. Spectrum (b) was obtained from the esterified powder, where the new peak at 1710 cm−1 is the typical IR spectral absorption of the carbonyl group of the ester, proving the successful introduction of the ester group into the powder. The ¹H-NMR spectrum was obtained in deuterated water (FIG. 2). The peak at 6.3 ppm is the two protons of the C═C bond of the maleate, and the peak at 5.3 ppm is the starch methylene proton attached to the maleate, again demonstrating the successful grafting of the powder to the maleate group.

### EXAMPLE 2

### Preparation of FL-MA

The reaction was carried out under the same reaction conditions as in Example 1 (90° C., 5 h), and 225.2 g of dry product was obtained except for the addition of 2.6 g of TiCl₄ (1% by weight of dry raw material) as a catalyst. The maleic anhydride conversion was about 64%.

### EXAMPLE 3

### Preparation of FL-MA

Carried out under the same reaction conditions as in Example 1 (90° C., 5 h), except that the solvent was butanone, 204.9 g of dry product was obtained. The maleic anhydride conversion was about 40%.

### EXAMPLE 4

### Preparation of FL-MA

The same reaction conditions as in Example 1 were carried out, except that the solvent was methyl isobutyl ketone (MIBK) and the reaction temperature was 110° C. for 5 h, and 209.7 g of dry product was obtained. The maleic anhydride conversion was about 42%.

### EXAMPLE 5

### Preparation of FL-MA

Under the same reaction conditions as in Example 1 (90° C., 5 h) and except for the use of rice powder, 205.5 g of dry product was obtained. The maleic anhydride conversion was about 43%.

### EXAMPLE 6

### Preparation of ST-MA

The reaction was carried out under the same reaction conditions as in Example 1 (90° C., 5 h), except that corn starch (Starch) with 5% water content was used, and 215.5 g of dry product was obtained. The maleic anhydride conversion was about 56%.

### EXAMPLE 7

### Preparation of FL-MA

16.20 g of moderately dried wheat flour (8% moisture content) was added to a 100 mL autoclave reactor, followed by 9.80 g of maleic anhydride, 0.650 g of zinc chloride, and 40.0 ml of acetone. The reactor was kept tightly sealed. After checking for leaks with nitrogen, the reactor was heated to 110° C. and stirred for 3 hours. The reaction mixture was filtered. The solid was evaporated under reduced pressure using a rotary evaporator to remove residual solvent. 21.1 g of dry product was obtained. The solvent can be recycled and reused in the next reaction. The filtrate was analyzed by GC and the conversion of maleic anhydride was confirmed to be about 55%.

### EXAMPLE 8

### Preparation of FL-MA Under Solvent-Free Conditions

324.0 g of moderately dry wheat flour (2% moisture content) was charged into a 1500 mL three-necked flask equipped with a thermometer and a mechanical stirrer, followed by the addition of 157.0 g of maleic anhydride, and 13 g of zinc chloride. The flask was heated and stirred in an oil bath at 120° C. for 2 hours. The reaction mixture is dissolved directly in water, and the adhesive can be formulated by adding the curing additive-ammonium chloride, and storage stabilizer (sodium chlorate).

### EXAMPLE 9

### Preparation of FL-MA Under Solvent-Free Conditions

In a blender 324.0 g of moderately dried wheat flour (5% moisture content) was mixed with 157.0 g of maleic anhydride and 13 g of zinc chloride. The mixture was transferred to a rotary reactor and heated to 120° C. under rotating conditions kept for 1 hour. The resulting solid reaction mixture was cooled to room temperature, crushed and powdered to a powder that can be used directly for adhesive formulation.

### EXAMPLE 10

### Preparation of FL-MA Under Solvent-Free Conditions

In a blender 324.0 g of moderately dry wheat flour (5% moisture content) was mixed with 157.0 g of maleic anhydride and 13 g of zinc chloride. The mixture was extruded through a twin-screw extruder at 100 rpm with an average retention time of 5 minutes at 130° C. The reaction mixture was cooled to room temperature, pulverized to a powder that can be used directly for adhesive formulation.

### EXAMPLE 11

The functionalized (esterified) flour obtained from the preparation of Example 1 was formulated into a heat solidified viscous liquid wood adhesive according to a powder-MA:H₂O:hardener of 40:55:5 (w/w/w).

Performance test of bio-based formaldehyde-free adhesives

### TEST EXAMPLE

The performance of bio-based formaldehyde-free wood adhesives (i.e., thermal curable tacky liquid wood adhesives) was tested by gluing plywood samples with bio-based formaldehyde-free wood adhesives (i.e., heat-curing tacky liquid wood adhesives), applying the bio-based formaldehyde-free wood adhesives to the preparation of the plywood samples, and said bio-based formaldehyde-free wood adhesives were formulated with a variety of curing additives (e.g., ammonium chloride, sulfuric acid (SA), p-toluene sulphonic acid (PTSA, tosic acid), phosphoric acid (PA)) or a combination of these curing agents, followed by mechanical property assessment (bond strength and wood failure under dry/wet conditions).

Double-layer plywood samples: prepared according to the following procedure (following ASTM International Standard 2017, D2339-98): a wet adhesive of approximately 0.12 g/in² (or 186 g/m²) was applied to a 4×12 inch board skin for plywood with a bonded area of 1×12 in². After drying in air for 10 minutes, another 4×12 inch board skin was placed on top. The samples were held at temperature for 4-8 minutes on a hot press preheated to 150-200° C. under 3 MPa pressure. The bonded two-layer plywood samples were cut into ten 4×1 inch pieces. The samples were then conditioned at 50±2% relative humidity and 23%±1° C. for 7 days until the weight no longer changed over time. Finally, the dry shear strength of each sample was measured using a universal testing machine (UTM), which measures the shear force required to cause damage to the adhesive layer (maximum breaking load).

Shear strength was calculated by dividing the force by the bond area.

In addition, water resistance was evaluated by testing the wet shear strength of the wood adhesive according to ASTM International Standards D2559-12a and D3434. Prior to measuring the shear strength, the double-layer plywood samples were exposed to two different wet conditions: case 1, the glued plywood samples were immersed in water at room temperature for 24 hours; case 2: the glued plywood samples were immersed in boiling water for 3 hours. In both cases, after the water immersion, the samples were dried and treated in a similar manner as described above before being tested for bond strength on the UTM.

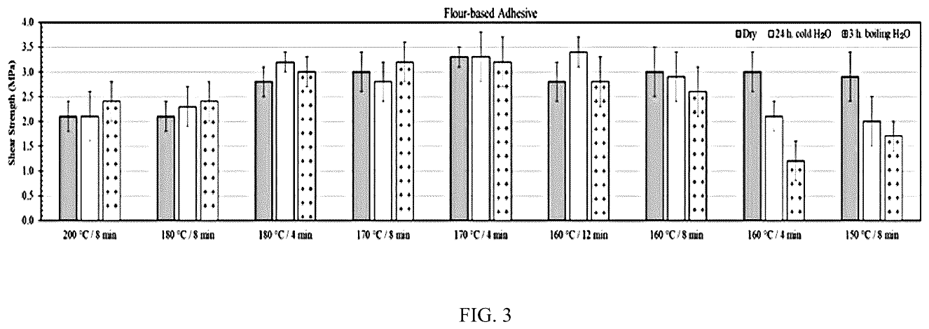

After the bond strength test, each plywood sample was tested for wood failure percentage according to ASTM International Standard D5266-13. The results of the adhesion test of the powder-based formaldehyde-free wood adhesive of Example 11 using ammonium chloride (5% NH₄Cl) as a curing additive for gluing two layers of plywood samples at different curing temperatures under different curing conditions are summarized in FIG. 3 and TABLE 1.

TABLE 1

| | | Wood failure % (standard deviation) | | | | | | | | |
|---|---|---|---|---|---|---|---|---|---|---|
| Test | | 200° C./ | 180° C./ | 180° C./ | 170° C./ | 170° C./ | 160° C./ | 160° C./ | 160° C./ | 150° C./ |
| Condition | | 8 min | 8 min | 4 min | 8 min | 4 min | 12 min | 8 min | 4 min | 8 min |
| Dry | | 100(±0) | 100(±0) | 100(±0) | 100(±0) | 100(±0) | 92(±8) | 94(±6) | 91(±9) | 80(±20) |
| Wet | 24 h, | 100(±0) | 100(±0) | 100(±0) | 100(±0) | 89(±11) | 96(±4) | 74(±7) | 25(±9) | 20(±14) |
| | cold | | | | | | | | | |
| | water | | | | | | | | | |
| | 3 h, | 100(±0) | 100(±0) | 100(±0) | 100(±0) | 73(±24) | 78(±22) | 87(±13) | 6(±4) | 5(±5) |
| | boiling | | | | | | | | | |
| | water | | | | | | | | | |

### EXAMPLE 12

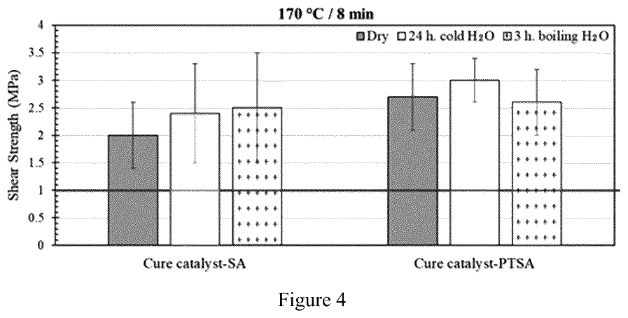

A thermo-curable wood adhesive was prepared with FL-MA (powdered-MA) as described in Example 1, and sulfuric acid (SA) was used for the curing additives, in the ratio of powdered-MA:H₂O:curing additives of 40:55:5 (w/w/w), and then a sample of a double-layered plywood panel was prepared (solidified for 4 min at 170° C. The shear strength and wood failure of the samples were tested as described in the Test Example, and the results are shown in FIG. 4 and TABLE 2.

### EXAMPLE 13

A thermo-curable wood adhesive was prepared with FL-MA as described in Example 1, and p-toluenesulfonic acid (PTSA) was used for the curing additive, in the ratio of powder-MA:H2O:curing additive of 40:55:5 (w/w/w), and then a sample of a double-layered plywood was prepared (cured for 4 min at 170° C. According to the procedure for preparation of a sample of a double-layered plywood). The shear strength and wood failure of the samples were tested as described in the Test Example by the method described in the Test Example. The results are shown in FIG. 4 and TABLE 2.

TABLE 2 demonstrates the percentage wood failure rate of the samples solidified at 170° C. for 4 min by wood adhesive bonding two layers of plywood with SA or PTSA as the curing additives.

TABLE 2

| | | Curing Additive(SA) | | Curing Additive(PTSA) | |
|---|---|---|---|---|---|
| | | Shear Strength | Wood Failure | Shear Strength | Wood Failure |
| | | (MPa)(standard | %(standard | (MPa)(standard | %(standard |
| Test Condition | | deviation) | deviation) | deviation) | deviation) |
| Dry | | 2.9(±0.4) | 97(±8) | 3.0(±0.4) | 100(±0) |
| Wet | 24 h, cold | 2.0(±0.4) | 60(±35) | 2.8(±0.4) | 92(±15) |
| | water | | | | |
| | 3 h, boiling | 2.7(±0.4) | 95(±12) | 1.9(±0.4) | 67(±38) |
| | water | | | | |

### EXAMPLE 14

A wood adhesive was prepared using FL-MA (powder-MA) as described in Example 1, a curing additive of NH4Cl+SA (weight ratio 1:1), and powder-MA:H₂O:curing additive of 40:55:5 (w/w/w), and then a sample of a double-layered plywood panel was prepared (cured for 4 min at 170° C. according to the procedure for preparation of a sample of a double-layered plywood panel). The shear strength and wood failure of the samples were measured as described in the Test Example by the method described in the Test example. The results of wet and dry strength and wood failure of the samples cured at 170° C. for 4 min with NH 4Cl+SA as the curing additive and the wood adhesive bonding the two layers of plywood are shown in TABLE 3.

TABLE 3

| | | Shear Strength (MPa) | Wood Failure % |
|---|---|---|---|
| Test Condition | | (standard deviation) | (standard deviation) |
| Dry | | 3.4(±0.4) | 100(±0) |
| Wet | 24 h, cold | 2.9(±0.3) | 100(±0) |
| | water | | |
| | 3 h, boiling | 3.1(±0.2) | 100(±0) |
| | water | | |

As can be seen from the Examples 11-14, the wood failure rate and shear strength of the boards were different by using different curing additives. The ammonium salt can release ammonia and hydrogen chloride at the same time due to heating, and the former can cross-link the unsaturated double bonds, and the latter can promote the esterification. Due to the high temperature of the esterification reaction, the addition of another acid facilitates the esterification curing reaction, so the use of the composite curing additive containing the ammonium salt increases the degree of curing and the degree of cross-linking, which leads to the double-layered plywood samples having higher shear strength, and the water resistance and the wood-failure rate are both improved.

### EXAMPLE 15

During the preparation of powdered polyacid monoesters, the catalyst was ZnCl₂+p-toluenesulfonic acid (weight ratio 2:1), and the other steps were the same as in Example 1 to obtain a dry powdered-MA product. The test showed that the conversion of maleic anhydride was about 67%.

### EXAMPLE 16

During the preparation of powdered polyacid monoesters, the catalyst was ZnCl₂+phosphoric acid (weight ratio 3:1), and other steps were the same as in Example 1 to yield a dry powdered-MA product. The test showed that the maleic anhydride conversion was about 61.5%.

As can be seen from Example 15-16, the use of a multifunctional (esterification) catalyst is more likely to promote the degradation of the flour, thereby increasing the reaction activity of the flour and increasing the rate of esterification of the maleic anhydride are helpful to shorten the reaction time and improve the efficiency.

### EXAMPLE 17

During the process of preparing the powdery polyacid monoester, maleic anhydride and citric anhydride were used to form a mixed anhydride with a weight ratio of 1:1, and the other steps were the same as those in Example 1, yielding a powdery-complex anhydride monoester product.

Then in proportion to the powder-complex anhydride monoester:H₂O: curing additive (NH₄Cl) ratio of 40:55:5 (w/w/w) is formulated into a heat curing viscous liquid wood adhesive.

### EXAMPLE 18

In the process of preparing the thermal curable adhesive liquid wood adhesive, maleic anhydride+phthalic anhydride were used to form a composite anhydride in the ratio of 1:1 by weight, and the other steps were the same as in Example 1, to yield a dry powdered-complex anhydride monoester product.

The powdered-complex anhydride monoester:H₂O: curing additive (NH₄Cl) ratio of 40:55:5 (w/w/w) was then formulated to form a thermo-solidified tacky liquid wood adhesive.

### EXAMPLE 19

The other steps were the same as in Example 17, differing only in that maleic anhydride and succinic anhydride were formed into a composite anhydride in the ratio of 1:2 by weight.

The powder-complex anhydride monoester: H₂O: curing additive (NH₄Cl) ratio of 40:55:5 (w/w/w) was then formulated to form a thermo-curable tacky liquid wood adhesive.

The wood adhesive obtained in Example 17-19 was used to prepare a double-layer plywood sample (cured at 170° C. for 8 min according to the double-layer plywood sample preparation procedure). The shear strength and wood failure rate of the samples were tested as described in the Test Example, and the wet and dry strength and % wood failure rate results of the samples are shown in TABLE 4.

TABLE 4

| | | Shear strength | Wood Failure |
|---|---|---|---|
| | | (MPa)(standard | %(standard |
| Example Sample | Test Condition | deviation) | deviation) |
| Example 11 | Dry | 3.2(±0.4) | 100(±0) |
| | 24 h, cold water | 3.2(±0.3) | 89(±11) |
| | 3 h, boiling water | 3.1(±0.2) | 73(±24) |
| Example 17 | Dry | 3.4(±0.3) | 100(±0) |
| | 24 h, cold water | 3.3(±0.3) | 92(±5) |
| | 3 h, boiling water | 3.2(±0.2) | 91(±8) |
| Example 18 | Dry | 3.3(±0.5) | 100(±0) |
| | 24 h, cold water | 2.9(±0.3) | 95(±5) |
| | 3 h, boiling water | 3.1(±0.2) | 93(±7) |
| Example 19 | Dry | 3.0(±0.3) | 100(±0) |
| | 24 h, cold water | 2.9(±0.3) | 88(±5) |
| | 3 h, boiling water | 2.6(±0.2) | 79(±6) |

As can be seen from Examples 17-19, the use of composite anhydride in conjunction with the use of saturated acid can result in a more complete cure due to the fast esterification rate of saturated acid solidification, yielding a double-layer plywood sample with improved shear strength and wood failure, with high strength and water resistance.

### EXAMPLE 20

In the process of manufacturing the thermal curable viscous liquid wood adhesive, the manufacturing method of Example 15 was used to yield a dry powdery-MA product, and the curing additive was ZnCl₂+2% PA (weight ratio of 2:1), and other steps were the same as in Example 11, to yield the powdery-MA waterborne adhesive product. Finally, a double-layer plywood sample was produced according to the double-layer plywood sample preparation procedure, curing at 170° C. for 4 min. The shear strength and wood failure rate of the samples were tested as described in the test Example, and the results are shown in TABLE 5.

### EXAMPLE 21

Powdered-polyacid monoester was used as an esterified product of flour and maleic anhydride-citric anhydride (2:1) (i.e., of Example 17), and the curing additive was made of 4% NH₄Cl+2% PA (weight ratio 6:1), and other steps were the same as those in Example 11, and the shear strength and wood-failure rate of the prepared double-layered plywood samples (curing at 170° C. for 4 min) were measured as described in the Test Example, and the results are shown in TABLE 5.

TABLE 5
Composite curing additive effect

| | | Shear Strength | Wood Failure |
|---|---|---|---|
| Sample | | (MPa)(standard | %(standard |
| No. | Test Condition | deviation) | deviation) |
| Example 11 | Dry | 3.2(±0.4) | 100(±0) |
| | 24 h, cold water | 3.2(±0.3) | 89(±11) |
| | 3 h, boiling water | 3.1(±0.2) | 73(±24) |
| Example 20 | Dry | 3.5(±0.3) | 100(±0) |
| | 24 h, cold water | 3.3(±0.2) | 97(±3) |
| | 3 h, boiling water | 3.2(±0.3) | 98(±3) |
| Example 21 | Dry | 3.4(±0.5) | 100(±0) |
| | 24 h, cold water | 3.1(±0.3) | 95(±5) |
| | 3 h, boiling water | 3.4(±0.2) | 93(±7) |

With the use of the composite curing agent in Example 20-21, the shear strength and wood failure rate of the double-layered plywood samples were increased, which contributed to the increase in the curing speed to improve the adhesive strength and water resistance properties.

### COMPARISON EXAMPLE 1

### Preparation of MA-Esterified Powder: Flour-Maleate (FL-MA)

Wheat flour 162.0 g containing 12% water was loaded into a 1000 ml three-necked flask which was equipped with a thermometer on one side of the neck and a condenser for solvent reflux on the other side of the neck, followed by the addition of 98.0 g of maleic anhydride (MA), the addition of 6.50 g of ZnCl₂ as a catalyst and the addition of 400 ml of acetonitrile. The flask was heated and stirred in an oil bath at 90° C. for 5 hours. The product was found to be caked in the reactor and was difficult to remove. A sample was analyzed by GC and the maleic anhydride conversion was only about 19%. The reaction mixture was filtered and washed with reaction solvent to remove the catalyst and unreacted MA. The solid was evaporated under reduced pressure using a rotary evaporator to remove the remaining solvent. 181.1 g of dried flour-MA product was obtained.

As can be seen from Example 1 and Comparative Example 1, the higher water content (more than 12%) in powdery biomass feedstock has a negative impact on the efficiency of the esterification with anhydride, so it is necessary to strictly control the water content of the powdered feedstock, which is suitable for the range of 2-10%, preferably 2-8%, which is not only useful for controlling the moderate degradation, but also makes the product suitable for a certain requirement of viscosity and adhesive strength.

The present invention discloses a method of producing an inexpensive bio-based formaldehyde-free wood adhesive from a starch-based powdery material, which has several key features compared to the prior technology: (1) it utilizes low-grade or surplus or expired grain/crop products as raw materials; (2) it does not involve any toxic chemicals or environmentally problematic chemicals, and said production process can be carried out under solvent-based conditions or solvent-free conditions; (3) the product is completely free of formaldehyde; (4) the wet strength of the product (in cold and boiling water) is significantly higher than that of protein-based formaldehyde-free adhesives (about 2.2 MPa); (5) the product is safer to use and less costly than isocyanate formaldehyde-free adhesives; (6) the production process of this product adopts multifunctional catalyst to complete starch degradation and esterification reaction in one step; (7) the solidification of the product adopts a multifunctional catalyst, and at the same time passes the double bond cross-linking and esterification cross-linking reaction.

The wood adhesive prepared can be pre-formulated in an adhesive manufacturing factory or formulated in a wood product manufacturing factory.

Bio-based formaldehyde-free wood adhesives produced from low-grade or surplus food/crop products are suitable at the industrial level in terms of the significant economic and environmental benefits of their products.

The preceding description of the preferred Example of the present invention is presented to illustrate the principles of the invention and not to limit the invention to the particular Examples shown. The scope of the present invention is intended to be defined by all examples encompassed within the following claims and their equivalents.

What is claimed is:

1. A method of producing a cyclic anhydride monoester powder as wood adhesive from biobased feedstock, wherein, comprising: generating a functionalized powder feedstock by moderate degradation of starch-based feedstock of appropriate moisture content in the presence of a multifunctional catalyst, together with esterification of cyclic anhydride and the introduction of a curable functional group;
and forming a thermo-curable wood adhesive by mixing the isolated functionalized powder with water and adding a curing agent adhesive.

2. The method according to claim 1, wherein, the powdered raw material is a mixture of grain flour or other starch-based substance selected from one or more of wheat, corn, rice, potato, cassava, tapioca or one or more of the above plant starches formed in any ratio; and/or wherein said powdered raw material has a moisture content of 2-10%, preferably 2-8%.

3. The method according to claim 1, wherein, the step of acid anhydride esterification of the powdered mass is carried out at a temperature range of 60° C. to 180° C. for a period of 5 minutes to 10 hours, preferably at a temperature range of 80-160° C. for a period of 1 hour to 8 hours; and/or the step of acid anhydride esterification of the powdered mass is carried out at a controlled weight ratio of acid anhydride to powder at the ratio of 1:1 to 0.1:1 (w/w).

4. The method according to claim 1, wherein, said cyclic anhydride is a combination of any one or more of maleic anhydride, itaconic anhydride, citric anhydride, phthalic anhydride, succinic anhydride, and methylsuccinic anhydride; said cyclic anhydride is preferably an unsaturated anhydride or a combination of an unsaturated anhydride and a saturated anhydride; said unsaturated anhydride is selected from one or more of maleic anhydride, itaconic anhydride; said saturated anhydride is selected from one or more of citric anhydride, phthalic anhydride, butanedioic anhydride, methyl butanedioic anhydride; more preferably, the ratio of said unsaturated anhydride to the saturated anhydride is 1:0-2.

5. The method according to claim 1, wherein, the step of esterification of the seed powder with acid anhydride can be carried out under polar organic solvent or solvent-free conditions; said polar solvent is selected from one or a combination of acetone, tetrahydrofuran, acetonitrile, butanone, 1,4-dioxane, dimethylformamide, dichloromethane; and that the step is carried out in a stirred reactor, a rotary reactor, or an extruder.

6. The method according to claim 2, wherein, the step of esterification of the seed powder with acid anhydride can be carried out under polar organic solvent or solvent-free conditions; said polar solvent is selected from one or a combination of acetone, tetrahydrofuran, acetonitrile, butanone, 1,4-dioxane, dimethylformamide, dichloromethane; and that the step is carried out in a stirred reactor, a rotary reactor, or an extruder.

7. The method according to claim 3, wherein, the step of esterification of the seed powder with acid anhydride can be carried out under polar organic solvent or solvent-free conditions; said polar solvent is selected from one or a combination of acetone, tetrahydrofuran, acetonitrile, butanone, 1,4-dioxane, dimethylformamide, dichloromethane; and that the step is carried out in a stirred reactor, a rotary reactor, or an extruder.

8. The method according to claim 4, wherein, the step of esterification of the seed powder with acid anhydride can be carried out under polar organic solvent or solvent-free conditions; said polar solvent is selected from one or a combination of acetone, tetrahydrofuran, acetonitrile, butanone, 1,4-dioxane, dimethylformamide, dichloromethane; and that the step is carried out in a stirred reactor, a rotary reactor, or an extruder.

9. The method according to claim 1, wherein, the multifunctional catalyst is selected from any one of the following, or a combination thereof: Lewis acid, selected from one or more of ZnCl₂, FeCl₃, AlCl₃, BCl₃, BF₃, LaCl₃, SnCl₄, NH₄Cl, (NH₄)₂SO₄; Bronsted acid, selected from sulphuric acid, phosphoric acid, methanesulfonic acid one or more of benzenesulfonic acid; or other types of esterification catalysts, selected from one or more of tin esters, titanates; the amount of said multifunctional catalysts ranges from 0.5 wt % to 8 wt % of the total sum of the powders and anhydrides, preferably from 1-6 wt %.

10. The method according to claim 2, wherein, the multifunctional catalyst is selected from any one of the following, or a combination thereof: Lewis acid, selected from one or more of ZnCl₂, FeCl₃, AlCl₃, BCl₃, BF₃, LaCl₃, SnCl₄, NH₄Cl, (NH₄)₂SO₄; Bronsted acid, selected from sulphuric acid, phosphoric acid, methanesulfonic acid one or more of benzenesulfonic acid; or other types of esterification catalysts, selected from one or more of tin esters, titanates; the amount of said multifunctional catalysts ranges from 0.5 wt % to 8 wt % of the total sum of the powders and anhydrides, preferably from 1-6 wt %.

11. The method according to claim 3, wherein, the multifunctional catalyst is selected from any one of the following, or a combination thereof: Lewis acid, selected from one or more of ZnCl₂, FeCl₃, AlCl₃, BCl₃, BF₃, LaCl₃, SnCl₄, NH₄Cl, (NH₄)₂SO₄; Bronsted acid, selected from sulphuric acid, phosphoric acid, methanesulfonic acid one or more of benzenesulfonic acid; or other types of esterification catalysts, selected from one or more of tin esters, titanates; the amount of said multifunctional catalysts ranges from 0.5 wt % to 8 wt % of the total sum of the powders and anhydrides, preferably from 1-6 wt %.

12. The method according to claim 4, wherein, the multifunctional catalyst is selected from any one of the following, or a combination thereof: Lewis acid, selected from one or more of ZnCl₂, FeCl₃, AlCl₃, BCl₃, BF₃, LaCl₃, SnCl₄, NH₄Cl, (NH₄)₂SO₄; Bronsted acid, selected from sulphuric acid, phosphoric acid, methanesulfonic acid one or more of benzenesulfonic acid; or other types of esterification catalysts, selected from one or more of tin esters, titanates; the amount of said multifunctional catalysts ranges from 0.5 wt % to 8 wt % of the total sum of the powders and anhydrides, preferably from 1-6 wt %.

13. The method according to claim 1, wherein, said curing additive is an acidic curing additive, selected from Lewis acid and/or Bronsted acid: said Lewis acid, selected from any one of NH₄Cl, (NH₄)₂SO₄, (NH₄)₃PO₄, ZnCl₂, FeCl₃, AlCl₃, BCl₃, BF₃, LaCl₃, SnCl₄ any one or a combination thereof, said Bronsted acid, selected from any one of sulfuric acid, phosphoric acid, toluene sulfonic acid, or a combination; preferably, wherein the curing additive is comprised of an ammonium Lewis acid with a Bronsted acid, said ammonium Lewis acid being selected from one of NH4Cl, (NH₄)₂SO₄, (NH₄)₃PO₄, and said Bronsted acid being selected from any one or a combination of sulfuric acid, phosphoric acid, toluene sulfonic acid any one or a combination of any one or more of these; more preferably, the weight ratio of said ammonium salt Lewis acid to Bronsted acid is (1-6):1.

14. The method according to claim 2, wherein, said curing additive is an acidic curing additive, selected from Lewis acid and/or Bronsted acid: said Lewis acid, selected from any one of NH₄Cl, (NH₄)₂SO₄, (NH₄)₃PO₄, ZnCl₂, FeCl₃, AlCl₃, BCl₃, BF₃, LaCl₃, SnCl₄ any one or a combination thereof, said Bronsted acid, selected from any one of sulfuric acid, phosphoric acid, toluene sulfonic acid, or a combination; preferably, wherein the curing additive is comprised of an ammonium Lewis acid with a Bronsted acid, said ammonium Lewis acid being selected from one of NH₄Cl, (NH₄)₂SO₄, (NH₄)₃PO₄, and said Bronsted acid being selected from any one or a combination of sulfuric acid, phosphoric acid, toluene sulfonic acid any one or a combination of any one or more of these; more preferably, the weight ratio of said ammonium salt Lewis acid to Bronsted acid is (1-6):1.

15. The method according to claim 3, wherein, said curing additive is an acidic curing additive, selected from Lewis acid and/or Bronsted acid: said Lewis acid, selected from any one of NH₄Cl, (NH₄)₂SO₄, (NH₄)₃PO₄, ZnCl₂, FeCl₃, AlCl₃, BCl₃, BF₃, LaCl₃, SnCl₄ any one or a combination thereof, said Bronsted acid, selected from any one of sulfuric acid, phosphoric acid, toluene sulfonic acid, or a combination; preferably, wherein the curing additive is comprised of an ammonium Lewis acid with a Bronsted acid, said ammonium Lewis acid being selected from one of NH₄Cl, (NH₄)₂SO₄, (NH₄)₃PO₄, and said Bronsted acid being selected from any one or a combination of sulfuric acid, phosphoric acid, toluene sulfonic acid any one or a combination of any one or more of these; more preferably, the weight ratio of said ammonium salt Lewis acid to Bronsted acid is (1-6):1.

16. The method according to claim 4, wherein, said curing additive is an acidic curing additive, selected from Lewis acid and/or Bronsted acid: said Lewis acid, selected from any one of NH₄Cl, (NH₄)₂SO₄, (NH₄)₃PO₄, ZnCl₂, FeCl₃, AlCl₃, BCl₃, BF₃, LaCl₃, SnCl₄ any one or a combination thereof, said Bronsted acid, selected from any one of sulfuric acid, phosphoric acid, toluene sulfonic acid, or a combination; preferably, wherein the curing additive is comprised of an ammonium Lewis acid with a Bronsted acid, said ammonium Lewis acid being selected from one of NH₄Cl, (NH₄)₂SO₄, (NH₄)₃PO₄, and said Bronsted acid being selected from any one or a combination of sulfuric acid, phosphoric acid, toluene sulfonic acid any one or a combination of any one or more of these; more preferably, the weight ratio of said ammonium salt Lewis acid to Bronsted acid is (1-6):1.

17. The method according to claim 1, wherein, the synthesized functionalized powdery material is used as a substrate, and the thermal curable wood adhesive is formulated in the weight ratio of functionalized powder:H₂O:curing additive weight ratio 20-60:30-80:5; optionally, a surfactant, and a storage stabilizer are also added; wherein the weight ratio of the functionalized powder:surfactant weight ratio is 20-60:4; and the weight ratio of the functionalized powder:storage stabilizer is 20-60:2; wherein the surfactant is selected from one or more of sodium p-toluene sulfonate, sodium dodecylbenzene sulfonate, sodium lignosulfonate, and tween, and the storage stabilizer (or anti-mold and anti-fungal agent) is selected from one or more of sodium polychlorophenate, sodium benzoate.

18. The method according to claim 17, wherein, it further comprises the step of curing the thermal curable wood adhesive by applying the wood adhesive to the surface of the wood product, wherein the said thermo-curable wood adhesive cures for 2 to 10 minutes in hot press under a pressure of from 2 to 8 MPa at a temperature in the range of from 140° C. to 220° C.

19. The thermo-curable wood adhesive prepared by the method described in claim 1 is applied to a wide variety of the engineered wood products, wherein said wood product is selected from one or more of plywood, particleboard, fiberboard and oriented strand board (OSB).

20. The thermo-curable wood adhesive prepared by the method described in claim 2 is applied to a wide variety of the engineered wood products, wherein said wood product is selected from one or more of plywood, particleboard, fiberboard and oriented strand board (OSB).
